(19) United States
(12) Patent Application Publication
(10) Pub. No.: US 2026/0271846 A1
(43) Pub. Date: Sep. 17, 2026

(54) CENTER MAST GROWING STAND FOR INDOOR HORTICULTURE

(71) Applicant: Les Verts Living Inc., Winnipeg (CA)

(72) Inventors: Andrew Vickerson, Vancouver (CA); Geoffrey Gyles, Winnipeg (CA); Kerry Green, Winnipeg (CA); Oliver Kaulfuss, Vancouver (CA); Victoria Leung, Vancouver (CA); William Logan, Maple Ridge (CA); Jennifer Bailes, Winnipeg (CA); Rachel Green, Winnipeg (CA); Juan Mucino Flores, Vancouver (CA); Robbie Gordon Roberts, Port Moody (CA); Brian Douglas Giesbrecht, Vancouver (CA)

(21) Appl. No.: 19/470,530

(22) PCT Filed: Apr. 30, 2024
(86) PCT No.: PCT/CA2024/050580

§ 371 Date: Sep. 29, 2025

Related U.S. Application Data
(60) Provisional application No. 63/504,073, filed on May 24, 2023.

(51) Int. Cl. A01G 9/14

(52) U.S. Cl. CPC A01G 31/06; A01G 31/0233

(57) ABSTRACT

A growing stand for indoor horticulture features a framework having a base, an upright mast standing erect thereto. One or more shelves, at least one of which is height adjustable, are mounted to the mast in cantilevered relation thereto above the base. One or more respective growing trays are each placeable atop a respective shelf, and concealed plumbing behind the mast includes flexible hose manipulatable to reach different userselectable service points of varying elevation. The trays flank the mast via receipt thereof in rear insets of the trays, and a recessed shelf cavity in the bottom of each shelf supported tray conceals the shelf to give the tray a floating appearance. A basin floor of each tray slopes laterally downward to a center channel of rearwardly downward slope toward a drain port, where a dual inlet drain fitting enables flood and drain operation through the singular drain port.

### CROSS-REFERENCE TO RELATED APPLICATIONS

This application claims benefit under 35 U.S.C. 119(e) of U.S. Provisional Application No. 63/504,073, filed May 24, 2023, the entirety of which is incorporated herein by reference.

### FIELD OF THE INVENTION

The present invention relates generally to multi-tiered indoor growing stands having vertically spaced tiers for supporting and growing plant life thereon at different elevations in an indoor environment, for example for hydroponic horticultural purposes.

### BACKGROUND

In the field of indoor horticulture, multi-tiered growing stands are known to be embodied in the combination of some sort of supportive structural framework and a plurality of shelves supported thereon at different elevations of stacked relationship over one another, with each shelf supporting or embodying one or trays or basins in which plants may be hydroponically grown. Typically, such stands resemble a conventional shelving unit or rack of the type employed for any variety of storage purposes, where the structural framework includes a set of four upright corner posts, which a series of rectangular shelves each supported at its four corners by those four upright corners posts of the framework. A shortcoming of such rack-like designs is that the four cornered structural framework of surrounding relation to each shelf is of somewhat obstructive relationship to the shelf, making is awkward or inconvenient to access all regions of the shelf's overall growing area.

An alternative approach is shown in U.S. Patent Application US2015/0068121 by Mobile Farming Systems, Inc., where the structural framework instead features a pair of upright arms of upstanding and forwardly arcing relationship to ground level tank in which a nutrient solution is stored for pumped distribution to multiple shelves mounted to the front sides of the curved arms at different elevations of overhead relationship to the bottom tank. Each shelf appears to be embodied by a substantially enclosed basin that is of relatively narrow depth in the front-rear direction of the stand, has a singular row of holes its topside for receiving a set of discrete planting baskets. Each shelf is mounted in an aligned pair of notches in the front of the two curved arms. While a notable deviation from the conventional shelving rack style of indoor growing stand referenced above, this design appears to be quite limited in its capacity and adjustability, with the growing area of each shelf being limited to a singular row of discretely spaced baskets, and with no means of adjusting the relative elevations of the shelves.

Chinese utility model CN217644188U by Lanjian Intelligent Technology Co. Ltd. also deviates from the conventional shelving rack style of indoor growing stand, with a framework having a wheeled rectangular base with a singular upright post standing erect thereof from a rear side of the base. Multiple shelves are affixed to the upright post at respective non-adjustable elevations thereon in positions cantilevered forwardly therefrom in overhead relation of the wheeled base, and are each formed of a grid-work of criss-crossing frame members. Each shelf carries two separate growing basins thereon, one on each side of the post. Nutrient solution is delivered to the basins of each shelf via an array of pipes that are distributed alongside the post and are gravitationally fed from an inlet at a top end of the post. While doing away with the obstructive corner posts of a shelving rack design, there again appears be a lack of elevational adjustability of the shelves and basins, and an underutilization of available growing space, with each shelf being unoccupied at a central region thereof between its two basins and in front of the upright rear post.

So, while there have been prior deviations from the conventional four-post rack shelving configuration for indoor growing stands, there nonetheless remains room for further improvement to multi-tiered growing stands for indoor horticulture.

### SUMMARY OF THE INVENTION

According to a first aspect of the invention, there is provided a growing stand for indoor horticulture, comprising:
a supportive framework comprising:
   a base; and
   an upright support mast attached to said base and standing in erect relation thereto, said support mast having a frontside facing forwardly in a front/rear direction, an opposing backside facing rearwardly in the front/rear direction, and two lateral sides facing oppositely of one another in a lateral direction of orthogonal relationship to said front/rear direction;
one or more shelves mounted or mountable to the upright support mast at respective elevations thereon above the base in positions cantilevering forwardly from the upright support mast in overhead relation to the base, at least a subset of the shelves being adjustably mountable to the upright support mast at different user-selectable elevations thereof;
one or more respective growing trays each of greater width, in the lateral direction, than the upright support mast and each residing or placeable atop a respective shelf among said one or more shelves in a position thereby cantilevered forwardly from the upright support mast in a position spanning laterally across the frontside thereof, each growing tray having a basin floor and a perimeter wall surrounding said basin floor in a manner upstanding therefrom and cooperating therewith to define a fluid-fillable upper basin of the growing tray; and
concealed plumbing routed along the upright support mast in concealed relation behind the frontside, and between the lateral sides, thereof, and comprising flexible hose manipulatable in position to reach different user-selectable plumbing service points at varying elevations on the stand.

According to a second aspect of the invention, there is provided a growing stand for indoor horticulture comprising:
a supportive framework comprising:
   a base;
   an upright support mast attached to said base and standing in erect relation thereto, said support mast having a frontside facing forwardly in a front/rear direction, an opposing backside facing rearwardly in the front/rear direction, and two lateral sides facing oppositely of one another in a lateral direction of orthogonal relationship to said front/rear direction; and
one or more growing tiers each mounted to the upright support mast at a respective elevation thereon above the base in a position of forwardly cantilevered relation to said upright support mast, and overhead relation to the base, for growing of vegetation at each of said plurality of tiers;
wherein at least one component of the stand, selected from among:
(a) a respective growing tray of at least one of said one or more tiers,
(b) an enclosure installed on said base,
has a rear end of that resides adjacent relation to said support mast, and is characterized by an inset mid-segment of said rear end that is of forwardly inset relation to neighbouring outer segments of said rear end that flank said mid-segment on opposing sides thereof, and said inset-mid region of said rear end receives the support mast forwardly inset relation to said neighbouring outer segments of the rear end of said component, whereby said component flanks the support mast at both of said lateral sides thereof.

According to a third aspect of the invention, there is provided a growing stand for indoor horticulture, comprising:
a supportive framework comprising:
   a base; and
   an upright support mast attached to said base and standing in erect relation thereto, said support mast having a frontside facing forwardly in a front/rear direction, an opposing backside facing rearwardly in the front/rear direction, and two lateral sides facing oppositely of one another in a lateral direction of orthogonal relationship to said front/rear direction;
one or more shelves mounted or mountable to the upright support mast at respective elevations thereon above the base in positions cantilevering forwardly from the upright support mast, at least a subset of the shelves being adjustably mountable to the upright support mast at different user-selectable elevations thereof;
one or more respective growing trays each of greater width, in the lateral direction, than the upright support mast and each residing or placeable atop a respective shelf among said one or more shelves in a position thereby cantilevered forwardly from the upright support mast in a position spanning laterally across the frontside thereof, each growing tray having a basin floor and a perimeter wall surrounding said basin floor in a manner upstanding therefrom and cooperating therewith to define a fluid-fillable upper basin of the growing tray; and
wherein each growing tray has an upwardly recessed shelf cavity in an underside thereof for receiving a seating platform of the respective shelf in a manner recessed upwardly into said underside of the growing tray for concealment of said platform by said growing tray when seated atop said seating platform of the shelf.

According to a fourth aspect of the invention, there is provided a growing stand for indoor horticulture, comprising:
a supportive framework comprising:
   a base; and
   an upright support mast attached to said base and standing in erect relation thereto, said support mast having a frontside facing forwardly in a front/rear direction, an opposing backside facing rearwardly in the front/rear direction, and two lateral sides facing oppositely of one another in a lateral direction of orthogonal relationship to said front/rear direction;
one or more shelves mounted or mountable to the upright support mast at respective elevations thereon above the base in positions cantilevering forwardly from the upright support mast; and
one or more respective growing trays each of greater width, in the lateral direction, than the upright support mast and each residing or placeable atop a respective shelf among said one or more shelves in a position thereby cantilevered forwardly from the upright support mast in a position spanning laterally across the frontside thereof, each growing tray having a basin floor and a perimeter wall surrounding said basin floor in a manner upstanding therefrom and cooperating therewith to define a fluid-fillable upper basin of the growing tray;
wherein at least one of the one or more growing trays is further characterized by at least one of the following features:
(a) the basin floor slopes downwardly toward a lateral center of the growing tray;
(b) the basin floor comprises a center channel that is laterally centered thereon and runs forwardly and rearwardly thereof, and at which the basin floor is downwardly and rearwardly sloped; and
(c) a drain port fed by both an upper drain inlet and a lower drain inlet, of which the lower drain inlet has a smaller flow area, and resides at a lesser elevation, than said upper drain inlet.

According to a fifth aspect of the invention, there is provided a growing tray for indoor horticulture, said growing tray having a basin floor and a perimeter wall surrounding said basin floor in a manner upstanding therefrom and cooperating therewith to define a fluid-fillable upper basin of the growing tray, said perimeter wall including front and rear wall sections residing oppositely of one another in a first direction in which a depth of said growing tray is measured, and two lateral wall sections residing oppositely of one another in a second direction in which a width of said tray is measured, said growing tray being further characterized by at least one of the following features:
(a) the basin floor slopes downwardly toward a lateral center of the growing tray;
(b) the basin floor comprises a center channel that is laterally centered thereon and runs forwardly and rearwardly thereof, and at which the basin floor is downwardly and rearwardly sloped;
(c) a drain port fed by both an upper drain inlet and a lower drain inlet, of which the lower drain inlet has a smaller flow area, and resides at a lesser elevation, than said upper drain inlet; and
(d) the rear wall section has an inset mid-segment that resides between and is inset forwardly from two end-segments of said rear wall section.

According to a sixth aspect of the invention, there is provided, in combination, a growing tray for indoor horticulture and a support shelf for said growing tray, said growing tray having a basin floor and a perimeter wall surrounding said basin floor in a manner upstanding therefrom and cooperating therewith to define a fluid-fillable upper basin of the growing tray, wherein the growing tray has an upwardly recessed shelf cavity in an underside thereof that is sized and shape for receipt of a platform of the support shelf in a manner recessed upwardly into said underside of the growing tray for concealment of said platform of the support shelf by said growing tray when seated atop said platform of the support shelf.

According to a seventh aspect of the invention, there is provided, in combination, a growing tray for indoor horticulture and a support shelf for said growing tray, said growing tray having a basin floor and a perimeter wall surrounding said basin floor in a manner upstanding therefrom and cooperating therewith to define a fluid-fillable upper basin of the growing tray, wherein the basin floor has a ribbed profile with alternating lands and valleys, and the shelf comprises a flat platform and a plurality of up-bent support tabs standing upright from said flat platform at locations thereon corresponding to lands of the ribbed profile for seated receipt of the lands of the growing tray atop the up-bent support tabs of the shelf.

### BRIEF DESCRIPTION OF THE DRAWINGS

Preferred embodiments of the invention will now be described in conjunction with the accompanying drawings in which:

FIG. 1 is a top front perspective view of an inventive multi-tiered growing stand for indoor horticulture according to a first embodiment of the present invention.

FIG. 2 is a top rear perspective of the inventive multi-tiered growing stand of FIG. 1.

FIG. 3 is another top front perspective view of the inventive multi-tiered growing stand of FIG. 2, but with a respective growing tray of each tier omitted for illustrative purpose.

FIG. 4 is another top front perspective view of the inventive multi-tiered growing stand of FIG. 3, but with a base cabinet and plumbing componentry of the stand omitted for illustrative purpose.

FIG. 5 is another top front perspective view of the inventive multi-tiered growing stand of FIG. 1, but with select parts of the base cabinet omitted for illustrative purpose, and with a respective set of smaller insert trays removed from each growing tray.

FIG. 6 is an isolated top front perspective view of one of the growing trays of the inventive multi-tiered growing stand of FIG. 1.

FIG. 7 is an isolated bottom front perspective view of the growing tray of FIG. 6.

FIG. 8 is an isolated top plan view of the growing tray of FIG. 6.

FIG. 9 is a cross-sectional view of the growing tray of FIG. 8, as viewed along line A-A thereof.

FIG. 10 is a cross-sectional view of the growing tray of FIG. 8, as viewed along line B-B thereof.

FIG. 11 is cross-sectional view of the growing tray and shelf of one of the tiers of the inventive multi-tiered support stand, as viewed in the same cross-sectional plane as FIG. 9.

FIG. 12 is an isolated top rear perspective view of the one of the shelves of the inventive multi-tiered growing stand.

FIG. 13 is an isolated bottom front perspective view of one of the tiers of the inventive multi-tiered growing stand of FIG. 1.

FIG. 14 is an isolated bottom front perspective view of a lamp canopy of the inventive multi-tiered growing stand of FIG. 1.

FIG. 15 is a schematic cross-sectional view of a dual-inlet drain fitting installed in a drain-port of one of the growing trays of the inventive multi-tiered support stand.

FIG. 16 is a top front perspective view of a miniaturized second embodiment of the inventive multi-tiered support stand that has a lesser quantity of tiers and a smaller footprint.

FIG. 17 is an isolated a top front perspective view of one of the shelves of the of the inventive multi-tiered support stand of FIG. 16.

FIG. 18 is an isolated a top front perspective view of a lamp support for a lamp canopy of the inventive multi-tiered support stand of FIG. 16.

FIG. 19 is a cross-sectional view of a growing tray and corresponding shelf from one of the tiers of the inventive multi-tiered support stand of FIG. 16, as would be seen along line C-C of FIG. 20.

FIG. 20 is another cross-sectional view of the growing tray and shelf of FIG. 19, but as would be seen along line D-D thereof.

FIG. 21 is another cross-sectional view of the growing tray and shelf of FIG. 19, but as would be seen along line E-E thereof.

### DETAILED DESCRIPTION

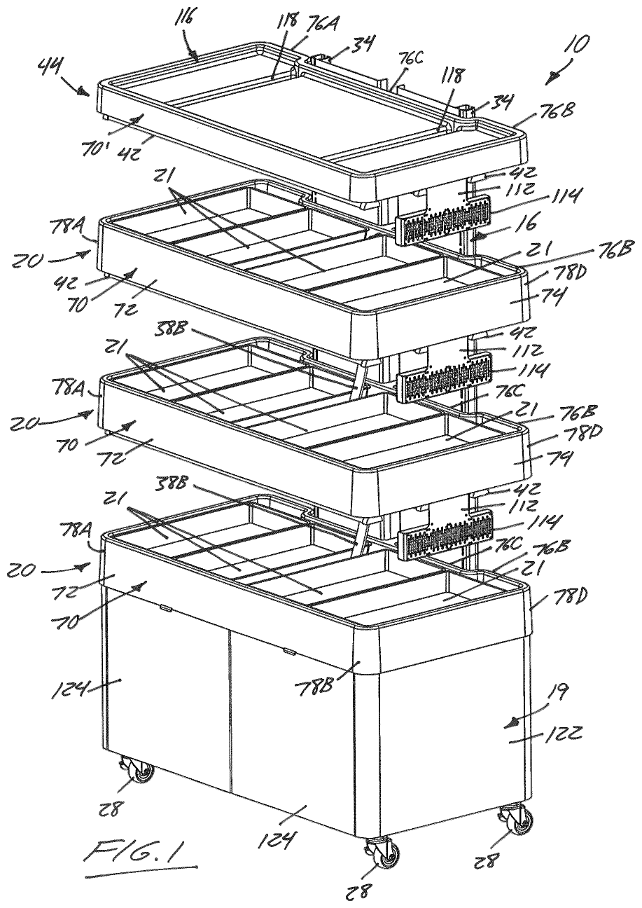

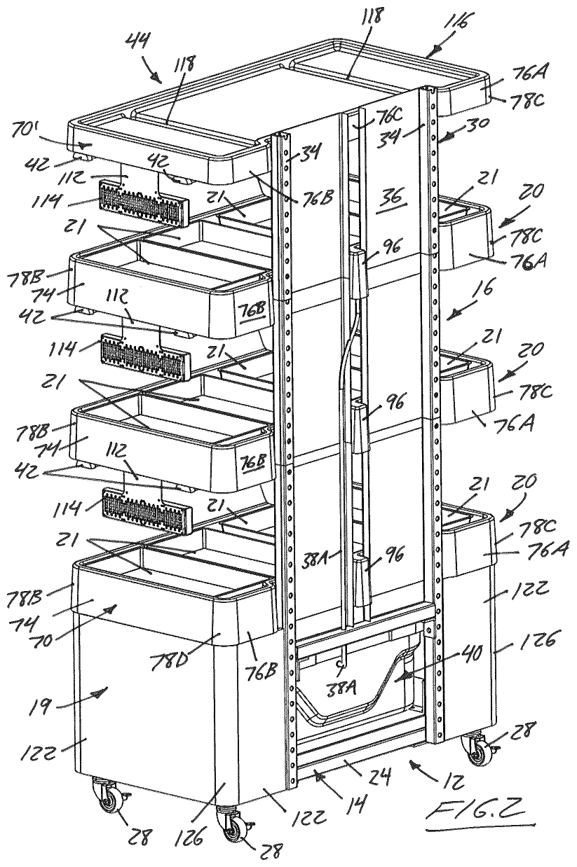

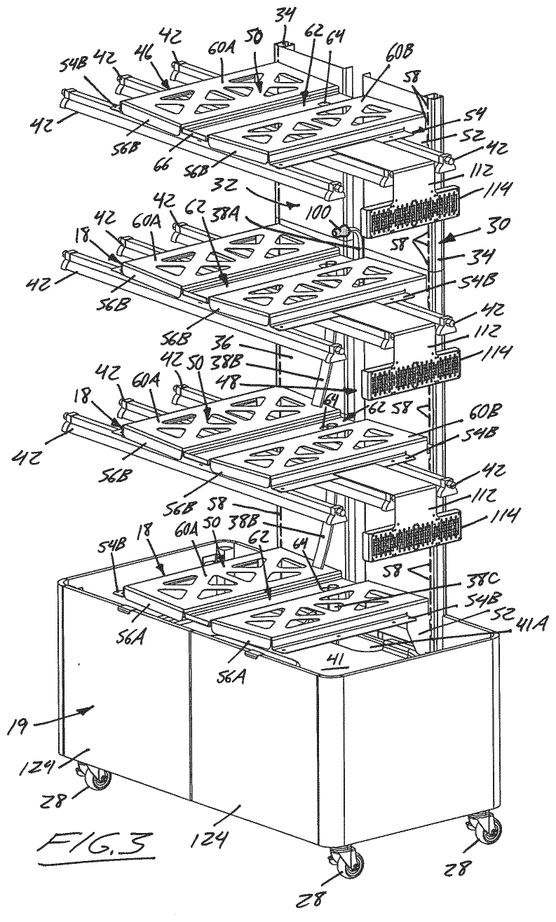

FIGS. 1 and 2 show a fully assembled multi-tiered indoor growing stand 10 of the present invention, useful for hydroponic or other indoor horticultural practices, such as the growing of fresh edible greens in a home environment or professional commercial kitchen. The main components of the stand 10 includes a supportive framework 12 having a base 14 (visible in FIG. 4) and an upright support mast 16, a plurality of shelves 18 mounted one over another at different respective elevations on the upright support mast 16 in overhead relation to the base 14, a plurality of growing trays 20 each disposed atop a respective one of the shelves 18 for growing of a respective plot of vegetation in the growing tray 20, and an enclosed base cabinet 19 installed at the base 14 of the framework 12 beneath the lowermost one of the shelves 18. Each shelf 18 and its respective growing tray 20 collectively denote a respective tier of the stand 10, each capable of hosting its own such respective plot of vegetation, for example with the ability to host different vegetation types at the different tiers. Each growing tray may be subdivided into smaller subplots, for example as illustrated by the optional inclusion of a respective set of smaller insert trays 21 optionally insertable into the growing tray 20. Some or all of the insert trays 21 may be water-permeable, for feeding of the insert tray's vegetation by nutrient solution circulated to the larger growing trays (as described in more detail below). On the other hand, one or more of the insert trays 21 may be water-impermeable, and thus not penetrable by the nutrient solution in the larger growing tray, for example for the purpose of hosting starters or other vegetation that are instead to be hand watered.

Referring to FIG. 4, the base 14 of the illustrated embodiment has a box-frame construction, being composed of front and rear beams 22, 24 that reside parallel of one another in horizontally spaced apart relationship to define opposing front and rear sides of the base 14, and a pair of cross-members 26A, 26B that span perpendicularly between the front and rear beams 22 to set the front and rear beams apart at a fixed distance. The horizontal direction in which the front and rear beams 22, 24 extend is referred to herein as a lateral direction, while the cross-members 26A, 26B are measured horizontally in a front/rear direction in which the front and rear beams are spaced apart, and which is of orthogonal relationship to the lateral direction. Each growing tray 20 has a depth measured in the front/rear direction, and a width measured in the lateral direction, of which said width exceeds said depth. To enable rolling movement of the stand 10 across a floor surface from one location to another, for example during initial placement and setup of the stand 10, or during later selective relocation thereof, a set of four wheels 28 are mounted to the base 14, at or near the terminal outer ends of the front and rear beams 22, 24. At least a subset, and the illustrated example an entirety, of the wheels 28 are preferably caster wheels to easy steering of the stand 10 during rolling movement thereof.

The upright support mast 16 is affixed to and stands vertically upright from the horizontal rear beam 24 in a position laterally centered between the outer terminal ends thereof, and a width of the support mast 16 in the lateral direction is less than a corresponding length of the rear beam 24, which is likewise measured in the lateral direction. A depth of the support mast in the front/rear direction is notably less than the width thereof in the lateral direction. The support mast 16 has two lateral sides 30 each facing laterally outward toward a respective nearest terminal end of the rear beam 24. A frontside 32 of the support mast 16 faces forwardly thereof, i.e. toward a vertical plane in which the front beam 22 of the frame resides. Each lateral side 30 of the support mast 16 is embodied at least partly by a respective one of two upright side rails 34, for example each formed of one or more lengths of metal channel. The frontside 32 of the support mast 16 is embodied by one or more front panels 36 (e.g. board or plates) spanning between, and affixed to, the two upright side rails 34 so as to substantially, though not entirely, close off the frontside 32 of the support mast 16. The space between the two upright side rails 34 behind the front panel(s) 36 is an open space through which at least some plumbing 38A and electrical wiring (not shown) of the stand 10 can be routed among the base cabinet 19 and the different tiers, in concealed relationship behind the front panel(s) 36 of the support mast 16.

In the illustrated embodiment, the mast-concealed plumbing comprises a filling hose 38A (best seen in FIG. 2) routed upwardly through the open space of the support mast 16 from a fluid reservoir tank 40 in the base cabinet 19 up to a filling port of the topmost one of the growing trays 20 for feeding of nutrient solution thereto from the reservoir tank 40. Other plumbing, which as shown, may reside fully, or at least partly, outside the support mast 16 in a visually exposed manner, includes a set of inter-tier drain hoses 38B each running from a drain port of a respective non-lowermost one of the growing trays 20 each growing tray to the underlying growing tray of the next-highest tier beneath it, and a singular bottom tier drain hose 38C that runs from the drain port of the lowermost growing tray at the lowermost tier into the fluid reservoir tank 40 in the base cabinet 19. From this described plumbing setup with a singular filling hose 38A running from the reservoir tank 40 to only a singular (uppermost) one of the growing trays 20, it will be appreciated that the stand of the illustrated embodiment is setup for cascading distribution of nutrient solution to the various tiers in top-down fashion. The nutrient solution is pumped from the reservoir tank 40 to the growing tray of the uppermost tier, from which the pumped nutrient solution overflows from that growing tray into the growing tray of the next highest tier, with such cascading overflow from tier to tier continuing down to the lowermost tier, from which the cascading overflow then returns to the reservoir tank 40 for pumped recirculation. Other embodiments may employ other fluid distribution arrangements with differently routed plumbing, for example for individual filling and draining of each growing tray from and back to the reservoir tank 40 via dedicated filling and drain lines for each growing tray, rather than sharing the top-down cascading setup of the illustrated embodiment.

With the exception of the lowermost one of the shelves 18, each shelf has a set of lamps 42 installed on the underside of the shelf 18 to cast light downwardly toward the underlying tier beneath it, thereby providing the necessary light to grow the respective plot of vegetation hosted by said underlying tier. In the illustrated example, each such lamp set is composed of a set of (e.g. three) elongated LED tube lights each spanning in the lateral direction of the growing stand 10, but it will be appreciated that the type, quantity and layout of the lights used in each lamp set may vary. Lighting for the topmost tier of the growing stand 10 is provided by an overhead lamp canopy 44 that, like each tier, is mounted to the support mast 16 in a position cantilevering forwardly therefrom in elevated relation to the growing tiers and base cabinet 19. As shown, this lamp canopy 44 may feature a matching lamp set 42 of the same type possessed by the lamp-equipped tier shelves beneath it, with the lamp support 46 of the lamp canopy 44 optionally being of substantially similar or identical shape and configuration to the shelves 18 of the tiers, more detailed description of which is given herein further below. That being said, the lamp support 46 by which the lamp set 42 of the lamp canopy 44 is supported on the support mast 16 need not necessarily be of such substantially matching or identical shape and configuration to the shelves 18 of the growing tiers.

The electrical wiring (not shown) for each lamp set 42 among the tiers and lamp canopy 44 (and for any optional fan units accompanying such lamp sets, as contemplated in more detail further below) is preferably routed up the support mast 16 from the base cabinet 19 in concealed fashion behind the front panel(s) 36 thereof, just like the concealed plumbing 38A that fluidly serves the growing trays 20 from the reservoir tank 40. The shelves 18 of the tiers, and in the illustrated example also the lamp support 46 of the lamp canopy 44, are removably mountable to the support mast 16 at variable user-selected elevations thereon. To enable routing of plumbing and electrical wiring to such user-variable tier and lamp canopy elevations, the front panel(s) 36 preferably include(s) one or more vertically elongated slots 48 therein, as embodied in the illustrated example by a singular vertical slot 48 running a full or substantial height of the front panel(s) 36. A bottom end of the slot 48 resides at an elevation at or near the base cabinet 19, and a top end of the slot 48 resides at or near a top end of the support mast 16 wherein the upright side rails 34 and front panel(s) 36 terminate. Though not illustrated as such, the side rails 34 and front panel(s) 36 may be capped off at the top end of the support mast 16. The concealed plumbing 38A is embodied at least partially by flexible hose that can be selectively manipulated into various shapes and positions within the support mast 16 to serve various user-selectable plumbing service points at varying elevations on the stand. To enable such rerouting of the concealed plumbing 38A, the illustrated support mast is of an open-backed configuration, though an openable/closeable rear panel setup may optionally be included. The open-backed mast 16 of the illustrated embodiment is intended to be backed up against a wall, or placed back-to-back with the open-backed support mast of another growing stand, whereby the concealed plumbing and wiring is also concealed from the rear.

Not only can the top end of the flexible filling hose 38A be adjusted to varying elevation according to a user-selectable height on the support mast at which the user chooses to mount the shelf 18 of the uppermost tier, but a user can instead also choose to use the uppermost tier for non-hydroponic purposes lacking a need for pumped supply of a nutrient solution from the reservoir tank 40 to that uppermost tier, in which case the filling hose 38A may instead be routed to one of the other underlying tiers at a corresponding lower elevation on the support mast 16. So user-selection of a particular service point to which to route the filling hose 38A may be part of an elevational adjustment of the position of a given growing tray to be fluidly served with nutrient solution, or selection of a particular tray to be fluidly served from among a plurality of different growing trays at different already-set elevations. Any tray chosen for non-hydroponic use may have its respective drain hose removed, and its drain-point aperture 104 optionally plugged. While the illustrated embodiment shows the inter-tier drain hoses 38B and bottom tier drain hose 38C as hanging from their respective trays 20 completely outside the support mast 16 at positions situated forwardly of the front panel(s) 36 thereof, such drain hoses may alternatively reside in positions routed at least partially within or through the slot 48 for less visual prominence outside the support mast 16. Rather than a singular slot 48 running a full or substantially full height of the support mast 16, a series of shorter slots distributed discretely within the same overall elevational span of the illustrated singular slot 48 could instead be used for the same purpose of enabling user adjustment of plumbing and/or electrical service to any user-selectable tier elevation at which a shelf 18 and respective growing tray 20 may be supported.

Each shelf 18 of the illustrated embodiment is composed of a singular metal plate having several bends therein to achieve a multitude of different functional parts occupying different respective planes. These functional parts of the shelf 18 include a seating platform 50 that constitutes a significant majority of the plate's overall surface area and receives seated placement of the respective growing tray 20 atop said platform 50, two mounting ears 52 depending downward from the platform 50 at rear outer corners of the platform 50 for mounting engagement thereof with the support mast 16, and two L-shaped flanges 54 each joined to the platform 50 at a respective one of two lateral edges of the platform that reside oppositely of one another in the lateral direction. Each L-shaped flange 54 has a first leg 54A that depends downwardly from the respective lateral edge of the platform 50, for example in coplanar relationship to a respective one of the mounting ears 52 at a position just in front thereof, and then a second leg 54B that juts a short distance perpendicularly outward from the first leg 54A, thus reaching laterally outward from the platform 50 at a downwardly offset elevation therefrom. Each mounting ear 52 has a pair of hooked tabs 52A, 52B projecting from its rear edge, thus projecting beyond the vertical plane shared by this rear edge of the mounting ear 52 and a corresponding rear edge of the platform 50, which as shown, may be characterized by presence of one or more downturned rear flanges 56A.

For removable mounting of each shelf 18 to the support mast 16, the frontside 32 of the support mast has two vertically arrayed series of mounting slots 58 therein, each running linearly up the frontside 32 thereof in close adjacency to a respective one of the support column's two lateral sides 30. The spacing of adjacent slots 58 in each series corresponds to the spacing of the two hooked tabs 52A, 52B of each mounting ear 52 so that the two hooked tabs 52A, 52B of each mounting ear 52 are engageable in any adjacent pair of mounting slots 58 in the respective series near the respective lateral side of the support mast 16. Such hooked engagement of the four mounting ear tabs 52A, 52B of the shelf 18 in two pairs of the mounting slots 58 secures the shelf 18 in a position cantilevering the shelf platform 50 forwardly from the frontside 32 of the support column 16 in perpendicular relationship to the vertical plane of the front panel(s) 36 thereof. In other variants (not shown), the shelves 18 may be alternatively shaped with mounting ears positioned and oriented to reside externally adjacent the lateral sides 30 of the support column 36 for fastened connection thereto at similarly arrayed mounting slots or holes at the lateral sides 30 of the column rather than at the frontside 32 thereof. In the illustrated example however, the front panel(s) 36 span(s) across open front sides of the metal channel side rails 34, and hook(s) around outer front corners thereof so that the front panel(s) wrap(s) over the laterally outward faces of the side rails 34. The mounting slots 58 are therefore defined in the front panel(s) 36, not the side rails 34, in the non-limiting example of the illustrated embodiment. The open-front channel shape of each side rail 34 accommodates receipt of the two hooked tabs 52A, 52B of the respective mounting ear 50 in the hollow interior of the side rail 34 upon insertion of the hooked tabs 52A, 52B through the mounting slots 58 in the front panel(s) 36.

Rather than having the side rails 34 open at their front side and overlaid thereat by slot-perforated front panel(s) 36 of sufficient thickness and strength, the rails (e.g. formed of metal tubing, or re-oriented metal channel) could instead have front walls with mounting slots likewise arrayed therein to receive the hooked tabs 52A, 52B of the mounting ears 52. In the case of slotted side rails 34, the front panel(s) 36 may still overlap the front sides of the rails 34 and feature matching slots therein of aligned relationship to those in the side rails, in which case, the thickness of the front panel(s) may be reduced, given lesser reliance thereon to bear the weights of the shelves and trays. Alternatively, in instances where the shelves are mounted directly to slotted rails, the front panel(s) could be reconfigured in a manner that no longer covers the front sides of the rails, and thus wouldn't overlie the mounting slots arrayed therein.

The seating platform 50 of each shelf 18 is divided into three distinct platform regions: two sloped outer regions 60 collectively denoting a majority of the platform's surface area, and a recessed central receiving channel 62 disposed between the two sloped outer regions 60A, 60B. Each sloped outer region 60 spans a full depth of the shelf in the front/rear direction of the stand 10 from a front perimeter edge of the platform 50 to the opposing rear edge thereof, where downturned rear flanges 56A reside between the two mounting ears 52 of the illustrated rear-flanged example. The two outer platform regions 60A, 60B are situated symmetrically of one another across the central receiving channel 62, but are not coplanar with one another. Instead, each outer region 60 occupies an inclined plane that slopes downwardly toward the central receiving channel 62 in the lateral direction of the stand 10. As described in more detail below, the respective growing tray 20 of each tier rests atop the two sloped outer regions 60 of the shelf's seating platform 50.

The receiving channel 62 between the two sloped outer regions 60A, 60B has a pair of symmetric sidewalls 62A, 62B that each depend a short distance downward from an inner edge of a respective one of the sloped outer regions 60A, 60B. A floor 62C of the channel 62 spans between the two channel sidewalls 62A, 62B at bottom ends thereof. The channel floor 62C is thus elevationally offset in a downward direction from the platform's sloped outer regions 60A, 60B, whereby the channel 62C is of recessed relation to the neighbouring outer regions 60A, 60B. The channel 62, like each of the sloped outer regions 60A, 60B, spans the full depth of the shelf 18, and the channel floor 62C has a plumbing aperture 64 therein near the rear edge of the platform 50 to accommodate routing of one of the drain hoses 38B, 38C therethrough. As shown, the downturned rear flanges 56 may span the rear edge of the platform 50 at only the sloped outer regions 60A, 60B thereof, and not at the central channel 62. Like at the rear edge, the opposing front edge of the platform 50 may likewise feature a pair of downturned front flanges 56B at the platform's two outer regions 60A, 60B, with the central channel 62 optionally having an upturned flange 66 at its front end between the downturned front flanges 56B.

Each growing tray 20 has an outer perimeter wall 70 composed of four wall sections that collectively form a generally rectangular perimeter shape of the tray. More specifically, the perimeter wall 70 has a front wall section 72 that spans in the lateral direction of the stand 10, two lateral wall sections 74 that extend rearwardly from opposing ends of the front wall section 72, and a rear wall section 76 that interconnects the two lateral wall sections 74 at rear ends thereof at a position of opposing relationship to the front wall section 72. The front and lateral wall sections 72, 74 maintain linearity over substantially full lengths thereof, deviating from such linearity only at four radiused outer corners 78A, 78B, 78C, 78D of the tray 20. The rear wall section 76 on the other hand is composed of three distinct linear segments: two outer segments 76A, 76B that each join up with a respective one of the lateral wall sections 74 at a respective one of the tray's rear outer corners 78C, 78D, and an inset mid-segment 76C that is forwardly offset from the two outer segments 76A, 76B of the rear wall section 76. A width of the inset mid-segment 76C, measured in the lateral direction of the stand 10 from one of the outer segments 76A of the tray's rear wall section 76 to the other outer region 76B thereof, slightly exceeds the width of the support mast 16 in this lateral direction. In the installed position of each growing tray 20, seated atop the platform 50 of its respective shelf 18, the support mast 16 is received in forwardly inset relation to the rear end of the growing tray 20. The frontside 32 of the support mast 16 resides in forwardly offset from the two outer segments 76A, 76B of the tray's rear wall section 76 in abutment with, or at least close adjacency to, the inset mid-segment 76C of the tray's rear wall section 76. The tray 20 thus wraps or hugs around the frontside 32 of the support mast 16 such that the two rear corners 78C, 78D of the tray 20 flank the support mast 16 at the opposing lateral sides 30 thereof.

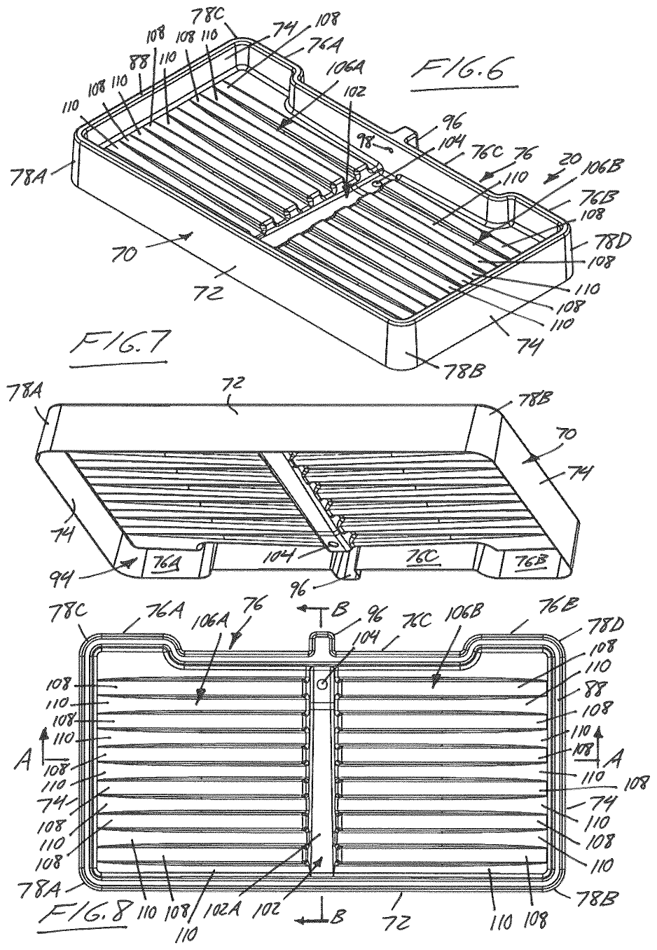

The perimeter wall 70 of each growing tray has a double-walled channel profile, as best revealed in the cross-sectional views of FIGS. 9 through 11. The channel profile of the perimeter wall 70 includes an inside wall 80 of integrally joined and upstanding relation to a basin floor 82 of the growing tray 20, and also an outside wall 84 that is of external relationship to the inside wall 80 and defines an outermost periphery of the growing tray 20. A top wall 86 of the channel profile integrally interconnects the inner and outside walls 80, 84 at the top ends thereof, and defines an uppermost perimeter rim 88 of the growing tray. The outside wall 84 extends further downwardly from the top wall 86 than the inside wall 82, and thereby reaches downwardly beyond the basin floor 82 to define a lower skirt 90 of the growing tray. The inside wall 80 of the perimeter wall's channel profile runs along all four perimeter edges of the basin floor 82 in cooperating relationship therewith to delimit a fluid-fillable upper basin 92 of the growing tray 20. Meanwhile, an underside of the basin floor 82 and the lower skirt 90 of the growing tray (as defined by the part of the outside wall 84 that reaches downwardly beyond the basin floor 82) cooperatively delimit a lower shelf cavity 94 of the growing tray 20 that resides beneath the upper basin 92 in upwardly recessed relationship to a bottommost end of the tray. In the illustrated example, the bottommost end of the tray refers a lowermost plane of the growing tray occupied by a terminal edge of the perimeter wall profile at the bottom end of the outside wall 84.

Midway along the inset mid-segment 76C of the tray's rear wall section 76, the outside wall 84 of the perimeter wall's channel profile has a localized bump-out 96 of rearwardly protruding relationship to the rest of the inset mid-segment 76C. At an aligned position across from this bump-out 96 of the outside wall 84, the inside wall 80 has a fill-port aperture 98 therein at an elevation above the basin floor 82. This this aperture 98, the top end of the filling hose 38A can be coupled to the tray 20 using a suitable hose fitting 100, thereby creating a functional filling port of the tray 20 through which nutrient solution can be pumped into the upper basin 92 of the tray 20 from the reservoir tank 40 in the base cabinet 19. The bump-out provides a localized widening of the double-walled channel profile at the location of the fill-port aperture to better accommodate the filling hose 38A within the hollow interior of the channel profile. Centered on the rear wall section 76 of the tray's perimeter wall 70, the bump-out 96 of the tray 20 is received in the centrally located upright slot 48 in the frontside 32 of the support mast 16, and so the filling hose 38A running up the backside of the front panel(s) 36 of the support mast 16 can reach up into the channel profile of the tray's perimeter wall to connect to the filling port in a concealed manner within the bump-out 96 of the tray's outside wall. By routing the filling hose 38A into a bump-out 96 that reaches into or through the frontside slot 48 of the support mast 16, the filling hose 38A need not emerge in exposed fashion from the frontside 32 of the support mast 16 to feed into the tray's upper basin 92.

The basin floor 82 features a recessed center channel 102 that runs the full depth of the tray 20 from the inside wall 80 of the front wall section 72 to the inside wall 80 of the rear wall section 76. As best shown in the cross-sectional view of FIG. 10, the basin floor 82, specifically at a floor 102A of this center channel 102, slopes downwardly in a rearward direction from its connection to the front wall section 72 to its connection to the rear wall section 76. A drain-port aperture 104 is provided in the floor 102A of the center channel 102 near a rear end of the center channel, at which the channel floor 102A integrally joins with the inside wall 80 of the rear wall section 76. On either side of the center channel 102, a respective outer region 106A, 106B of the basin floor 82 is characterized by a ribbed or corrugated profile, as viewed in cross-sectional planes cutting vertically through tray in the front/rear direction parallel to the center channel 102 (front/rear sectional planes, for short). Each ribbed outer region 106A, 106B thus has an alternating series of lands and valleys 108, 110, each denoting a laterally oriented strip of the basin floor running from the respective lateral wall section 74 of the tray 20 to the center channel 102 thereof, and of which the lands 108 reside at greater elevation than the valleys 110 between said lands.

At the floor 110A of each valley 110, the basin floor 82 slopes downwardly toward the central channel 102. By contrast, the lands 108 all reside coplanar with one another in a common horizontal plane of parallel relation to both the top rim 88 of the tray (denoting a topmost plane of the tray), and the bottommost plane of the tray (defined earlier as that occupied by the terminal bottom end of the skirted outside wall 84). Each valley is shallowest at an outer end thereof nearest the respective lateral wall section 74 of the tray 20, and deepest at an inner end thereof that opens into the recessed center channel 102. In any front/rear sectional plane, the valleys are of equal depth to one another (as measured from the shared plane of the lands 108), and so the elevations of the valley floors 110A relative to the sloped floor 102A of the center channel 102, in any such front/rear sectional plane, increase in a rearward direction moving from the front wall section 72 to the rear wall section 76. The relative elevations and angulations of the lands and valleys 108, 110 are best revealed in the cross-sectional view of FIG. 9, whose cutting plane cuts through a matching pair of lands 108 on either side of the central channel 102, relative to which the floors 110A of a matching pair of valleys 110 can be seen to be angularly offset from the respective lands 108 at a downward slope toward the center channel 102.

With reference to the growing tray 20 of the topmost tier of the stand 10, the result of this basin floor geometry is that nutrient solution pumped into the upper basin 92, through the fill-port hose fitting 100 on the rear wall section 76 of the tray, spills initially into the center channel 102 of the tray, and as the center channel 102 fills up, the solution then floods evenly into the valleys 110 of the corrugated basin floor regions 106A, 106B on either side of the center channel 102. This fills the valleys 110 uniformly to an elevation eventually reaching and then exceeding the lands 108, atop which hydroponic plant growth media is seated, whether directly, or within the water-permeable insert trays 21 that in-turn may be seated atop the lands 108 of the corrugated basin floor regions 106A, 106B on either side of the center channel 102. The center channeled, corrugated and inwardly sloped configuration of the basin floor 82 also has the benefit of concentrating the greatest water weight at the lateral center of the tray 20, improving the stability of the overall plant stand 10 during filling thereof.

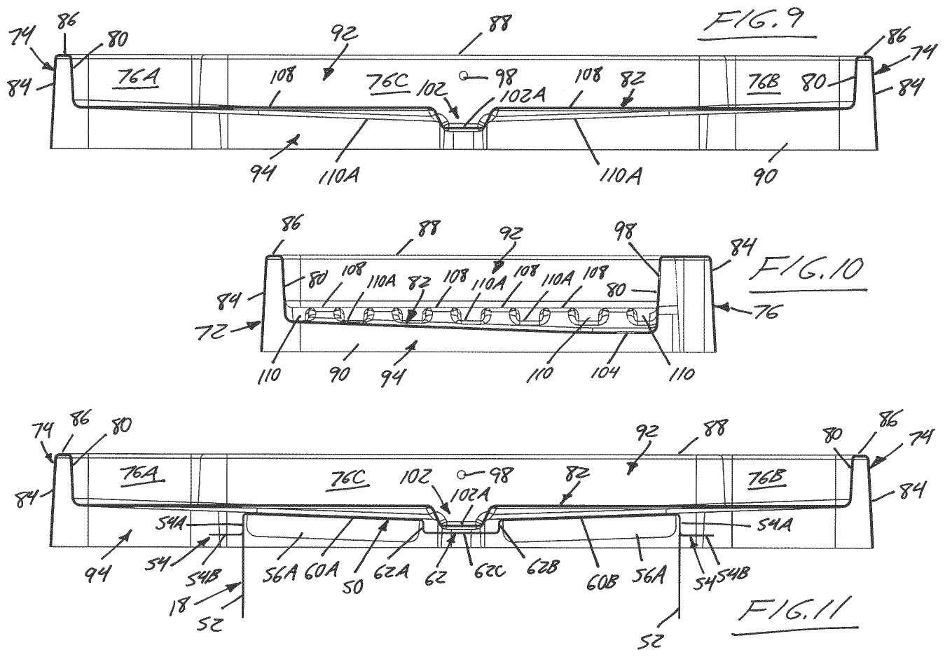

FIG. 11 illustrates the seated support of any one of the growing trays 20 atop its respective shelf 18, where it can be seen that inwardly declined angulation of the sloped regions 60A, 60B of the shelf platform 50 abut conformingly against the undersides of the likewise inwardly declined valley floors 110A of the corrugated basin floor regions 106A, 106B of the growing tray 20. This provides stable support of the growing tray 20 in a seated position atop the platform 50 of the shelf 18. Meanwhile, the central receiving channel 62 of the shelf 18 accommodates a downwardly protruding mid-ridge that exists in the underside of the basin floor 82 (i.e. at the topside of the shelf cavity 94) as a result of the recessed character of the center channel 102 of the basin floor 82 relative to the valley floors 110A thereof. Receipt of the center channel mid-ridge of the growing tray 20 in the corresponding center receiving channel 62 of the shelf 18 aids in proper alignment and seating of the growing tray 20 on the shelf 18, and also resists lateral shifting of the tray 20 on the shelf 18 once seated thereon. The inset position of the support mast 16 in the rear wall section 76 of the growing tray 20 likewise blocks lateral shifting of the growing 20 relative to its seated position on the shelf 18 when the shelf and tray combination is in its installed relation to the upright support mast 16.

Because the skirted outside wall 84 of the channel profiled perimeter wall 70 of the growing tray 20 depends downwardly past the seated interface of the basin floor 82 atop the shelf platform 50, the skirted outside wall 84 conceals the platform 50 and its various flanges 54, 56A, 56B of the shelf 18 from sight. Stated another way, a substantial entirety of the shelf 18, with the sole exception of the mounting ears 52, is recessed upwardly inside the lower shelf cavity 94 of the growing tray 20, and is thus concealed from sight, whereby the trays appear to “float” in front of the support mast 16. As shown in FIG. 11, the width of the shelf 18 in the lateral direction of the stand 10 is notably lesser than that of the lower shelf cavity 94 of the tray 20, as measured between the outer walls 84 of the lateral wall sections 74 that hang downwardly beyond the basin floor 82. The elongated lamps 42 of each lamp-equipped tier lie laterally of the shelf 18 at an underside thereof, and are each fastened to the laterally projecting second legs 54B of the L-shaped lateral flanges 54 of the shelf 18, in positions projecting outwardly therebeyond. The length of each lamp 42 is slightly lesser than the width of the shelf cavity 94 of the growing tray 20 seated atop the shelf 18, and the lamp-supporting second legs 54B of the L-shaped lateral flanges 54 of the shelf 18 reside above the lowermost plane of the growing tray 20. Accordingly, each lamp 42 is at least partially recessed upwardly into the lower shelf cavity 94 of the overlying growing tray 20, thus increasing the available plant canopy capacity of the underlying tier, as measured from the growing tray thereof up to the lamps of the overlying tier or lamp canopy.

In addition to providing mounting support for the lamps 42, one of the two lateral flanges 54 of the shelf 18 of each non-lowermost tier is also used for mounting of a fan support bracket 112 that initially projects laterally off to one side of the shelf 18, and then turns downwardly out from the lower shelf cavity 94 of the growing tray 20 at a position just inside the skirt-defining outside wall 84 of the respective lateral wall section 74. Here, a short elevation below the growing tray 20, the fan support bracket 112 carries a fan unit 114, in which there are embodied one or more electrically powered fans that face toward the opposing end of the tier and are thereby operable to blow air laterally across the plant canopy of the underlying tier from one end thereof to the other.

In another embodiment (not shown), instead of the open-backed support mast 16 accompanied by tier-specific shelf-mounted fan units 114, the support mast 16 may be closed off at the backside thereof by a rear wall of opposing and spaced relation to the front panel(s) 36, whereby the plumbing/wiring space between side rails 34 of the mast 16 can double as an air duct for routing air up to the tiers from a shared fan, for example installed in the base cabinet 19. In such embodiments, airflow slots in the front panel(s) could be included on either side of the central slot 48 to emit the ducted airflow at the various plant growth tiers. Such airflow slots may be accompanied by openable/closable dampers to vary the amount of airflow therethrough, preferably in a manner independently adjustable at various elevations, and optionally on either side of the central upright slot 48, to enable different airflow characteristics at different tiers, and optionally at each lateral half of each tray, for example to suit a plant variety or plant growth stage hosted at different plots and subplots. Such airflow slots may be accompanied by vertical guide vanes or guide fins suitably positioned and oriented relative to the airflow slots to direct a fraction of the airflow laterally outward from the centrally located support mast 16, and thereby distribute the airflow more fully across each tray 20, preferably achieving a full 180-degree air diffusion pattern emanating from the frontside 32 of the support mast 16. Rather than fully enclosing the backside of the support mast 16 to use an entirety of the support mast's interior as an effective air duct, one or more smaller ducts may run internally up the mast in the space behind the front panel(s) and between the side rails 34, for example, one on each side of the central slot 48. In another variant that likewise includes airflow slots in the front panel(s) 36 to distribute airflow to each tier from the support mast 16, rather than from a shelf-mounted fan unit 114, multiple fan units may be installed in the support mast behind the front panel(s) 36 and between the side rails 34 to blow air through such airflow slots at different elevations of the support mast, as an alternative to the ducting of such airflow from a shared fan unit in the base cabinet 19.

In the illustrated embodiment, the lamp support 46 of the lamp canopy 44 is of identical construction to the shelves 18 of the tiers, is installed on the support mast 16 in identical fashion to those tier shelves 18, and has a respective lamp set 42, fan support bracket 112 and fan unit 114 installed thereon in identical fashion to the uppermost and second uppermost tiers (i.e. the non-lowermost tiers) of the three-tiered example. Though the illustrated example has all the fan support brackets 112 installed at matching ends of the lamp canopy 44 and non-lowermost tiers, it will be appreciated that the fan support bracket 112 may be mounted to either one of the two lateral flanges 54 of each shelf 18 or lamp support 46. The lamp canopy 44 of the illustrated embodiment also has a canopy cover 116 installed atop the lamp support 46, which like the growing trays 20 has lower shelf cavity 92′ skirted by a perimeter wall 70′ whose rear wall section 76′ again has an inset mid-segment 76C flanked to by outer segments 76A, 76B so that the canopy cover 116 embraces or hugs the frontside 32 of the support mast 16 in a manner flanking both lateral sides 30 thereof. However, since the canopy cover 116 isn't used for growing, it need not embody the corrugated and centrally channeled basin floor 82 of the growing trays 20, and instead may simply have two depressed mounting channels 118 in the topside of the cover 116, which create two corresponding and downwardly protruding mounting ridges in the topside of the cover's shelf cavity 92′. These mounting ridges sits atop the laterally projecting second legs 54B of the lamp support's lateral flanges 54 for fastening of the cover 116 to these flanges 54 of the lamp support 46 via fastening holes provided in the floors of the two depressed mounting channels 118.

Referring to FIG. 5, the base cabinet 19 has a cabinet floor 120 installed atop the rails 22, 24 and cross-members 26 of the framework base 14, for example in the form of a metal sheet with downturned flanges at its two ends that wrap downwardly over the terminal outer ends of the front and rear rails 22, 24. The reservoir tank 40 sits atop the cabinet floor 120, in an enclosed fashion encompassed by a combination of cabinet walls 122 that stand upright from perimeter edges of the cabinet floor 120, and one or more openable cabinet doors 124 at the front face of the cabinet 19. As shown in FIG. 3, the base cabinet 19 may lack a dedicated top wall, and instead rely upon the shelf-supported growing tray 20 of the lowermost tier to effectively cap-off the otherwise open top of the base cabinet 19. The bottom tier drain hose 38C coupled to a drain fitting installed in the drain-port aperture 104 of the growing tray 20 of the lowermost tier runs downwardly into the interior space of the base cabinet 19 through the open top thereof, via the plumbing aperture 64 in the shelf 18 of the lowermost tier. Likewise, the same plumbing aperture 64 in the other tiers accommodates routing of the inter-tier drain hoses 38B downwardly from the fitting-equipped drain-port apertures of their respective growing trays to the growing trays of the underlying tier(s) beneath them.

As shown in FIG. 2, the support column 16 is forwardly inset into a rear end of the base cabinet 19 the same way that it is inset into the rear ends of the growing trays at the inset mid-segments 76C thereof, whereby the two rear corners 126 of the base cabinet flank the support mast 16 at the lateral sides 30 thereof at positions aligned beneath the rear corners 78C, 78D of the lowermost tier's growing tray. Though the growing trays 20, lamp canopy cover 116 and base cabinet 19 all flank the support mast 16 on both sides, none of these mast-flanking components 20, 116, 19 project rearwardly beyond the backside of the support mast 16, and thus don't interfere with flush placement of the backside of the support mast 16 against a wall surface, or back-to-back with the support mast of another stand 10 for a mirrored back-to-back dual-stand growing setup. Referring to FIG. 3, where the otherwise enclosed interior of the base cabinet 19 is partially revealed through the open top thereof in absence of the lowermost tier's growing tray, it can be seen that a removable lid 41 of the reservoir may have an open rear notch 41A therein through which the bottom-tier drain hose 38C enters the reservoir in hanging fashion from the growing tray of the lowermost tier, whereby the removable lid can be accessed and pulled forwardly off the reservoir tank 40 via the openable front door(s) 124 of the cabinet 19, without requiring extraction of the bottom-tier drain hose 38C from the reservoir tank 40.

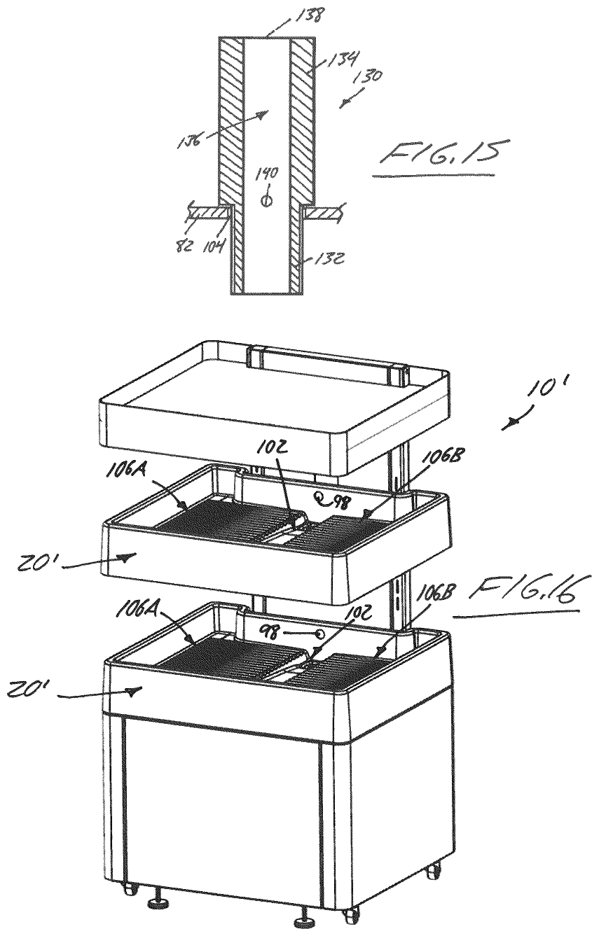

Finally, FIG. 15 illustrates installation of a respective dual-inlet drain fitting 130 in the drain-port aperture 104 of the basin floor 82 of each growing tray 20. The fitting has an externally threaded lower stem 132 whose outer diameter is less than the diameter of the drain-port aperture 104 to accommodate insertion of the lower stem 132 downwardly therethrough from inside the upper basin 92 of the growing tray 20. The threaded lower stem 132 can accept threaded engagement of a compatible nut (not shown) thereon from beneath the basin floor 82 in order to fasten the fitting 130 in place in the drain-port aperture 104. The lower stem 132 also receives the top end of the respective inter-tier or bottom-tier drain hose 38B, 38C of the given tier. An upper body 134 of the fitting 130 stands axially upright from the threaded stem 132, and has a larger outer diameter than the threaded stem 132. This larger outer diameter of the fitting's upper body 134 exceeds the diameter of the drain-port 104 so that the aforementioned fastening of a nut on the threaded lower stem 132 secures the fitting 130 in place in the basin floor 82 of the growing tray 20. A through bore 136 passes axially through the entirety of the fitting, from a top end of the upper body 134 to a bottom end of the lower body 132. The open top end of the through bore denotes an upper drain inlet 138 of the fitting. A lower drain inlet 140 of the fitting is instead defined by one or more lower ports penetrating radially into the axial through bore 136 through the circumferential wall of the upper body 134 at a short elevation above the externally shouldered transition between the lower stem 132 and upper body. Positioned as such, this lower drain inlet 140 resides only slightly above the basin floor 82 of the growing tray 20. The flow area of the lower inlet 140 (whether denoted by the flow area of a singular lower drain port, or the collective flow area of a plurality of smaller lower drain ports), is less than the flow area of the upper inlet 138.

The pump (not shown) responsible for pumped circulation of the nutrient solution from the reservoir tank 40 (e.g. a submersible pump residing within the tank) has a spec'd pumping rate, and the flow areas of the dual-inlet drain fitting 130 are tuned relative to this pumping rate (whether by selection of suitable inlet flow areas relative to the pump specs, or by selection of a suitably spec'd pump for given inlet flow areas) such that the allowable flow rate through the smaller lower drain inlet 140 is lesser than the pumping rate of the pump, while the allowable flow rate through the larger upper drain inlet exceeds the pumping rate, or at least exceeds the pumping rate minus the allowable flow rate of the lower drain inlet so that the combined allowable flow rates of the two inlets 138, 140 exceeds the pumping rate. This way, a lower drainage rate at which fluid can drain through the fitting 130 via the lower drain inlet 140 thereof is exceeded by the pumping rate, while an upper drainage rate at which fluid can drain through the fitting 130 via the upper drain inlet 138 is not exceeded by the pumping rate.

During flooding of the growing trays 20 with nutrient solution, operation of the pump initially begins filling the growing tray of the uppermost tier, during which a relatively small fractional stream of the incoming nutrient solution from the pump will trickle down to the growing tray 20 of the underlying tier via the lower drain inlet 140 just above the basin floor 82 of the uppermost tier's growing tray 20, while a majority of the incoming nutrient solution causes the solution level to rise in the growing tray of the uppermost tier. Under continued pumping, eventually the solution level in the growing tray of the uppermost tier reaches the top end of the dual-inlet drain fitting 130, at which point the nutrient solution in the growing tray of the topmost tier now starts also draining through the larger upper drain inlet 138, thus increasing the flow to the growing tray of the underlying tier through the inter-tier drain hose 38B. This accelerates the filling of that underlying tier's growing tray, which initially had drained in only trickling fashion to next underlying tier (or back to the reservoir, depending on the number of tiers) via the lower drain inlet 140 of the uppermost tier's dual-inlet drain fitting 130.

Since the flow area of the larger upper drain inlet 138 enables a combined inlet drainage rate exceeding the pumping rate, the solution level in the basin of the uppermost tier's growing tray 20 stops rising once the top end of the dual-inlet drain fitting 130 is reached. Once all trays are filled to this maximum level dictated by the height of their respective drain fittings 130, continued operation of the pump circulates nutrient fluid among the full set of trays. Once pump operation is ceased, gravitational drainage back to the reservoir tank 40 will still continue in cascading top-down fashion from tier-to-tier, making use of the lower drain ports 140 of the dual-inlet drain fittings 130. The height of the dual-inlet drain fitting 130 may be chosen to be less than the height of the fill-port aperture 98 in the rear wall section 76 of each growing tray 20 to avoid the need to plug the fill-port aperture 98 in any non-uppermost tier that is filled in cascading fashion from a higher tier via an inter-tier drain hose 38B, and thus don't make use of the fill-port aperture 98. The dual-inlet drain fitting 130 thus enables flood and drain operation of the plant stand 10 using only a singular drain port in the basin, whereby the minimized drain port quantity per tray 20 reduces the quantity of potential leakage failure points in the system, and reduces the overall amount of drain hoses and fittings required among the plumbing components.

It will be appreciated that the various powered components of the stand 10 (circulation pump, lights, fan(s)) may be controlled manually, or in automated fashion, for example via a programmed controller wired to such componentry, and mounted in the support mast 16 or base cabinet 19, in connection with a user-interface through which users can monitor operation of the stand 10 and select different operational parameters for the various powered components. Such user-interface may be embodied in the stand itself 10 as part of a dedicated on-board interface device (e.g. touch-screen display), or on a remote device (smartphone, tablet, etc.) that communicates wirelessly with the programmed controller of the stand 10.

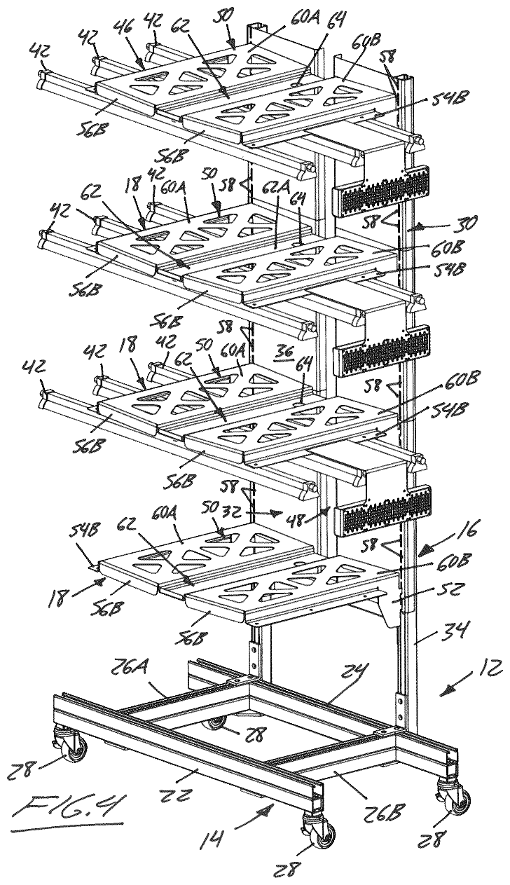

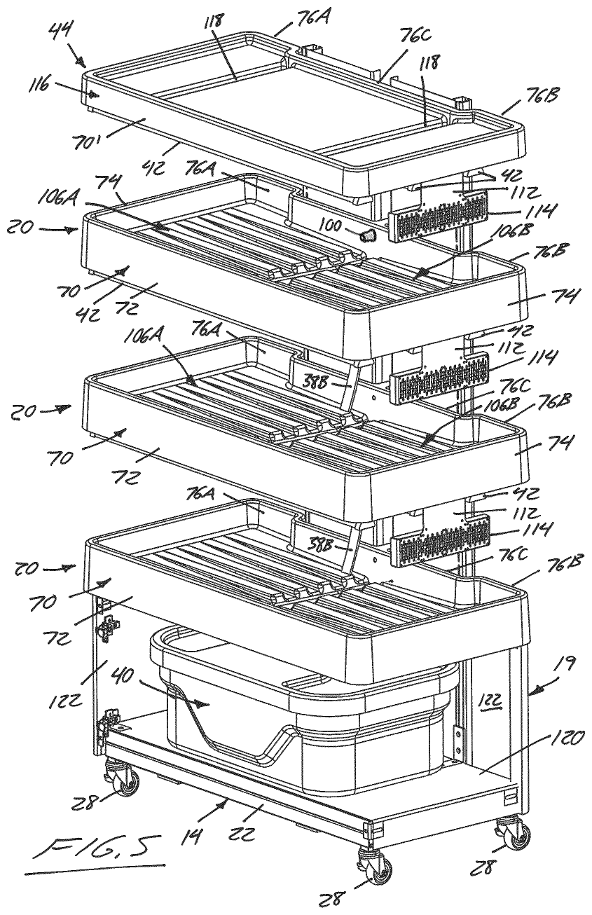

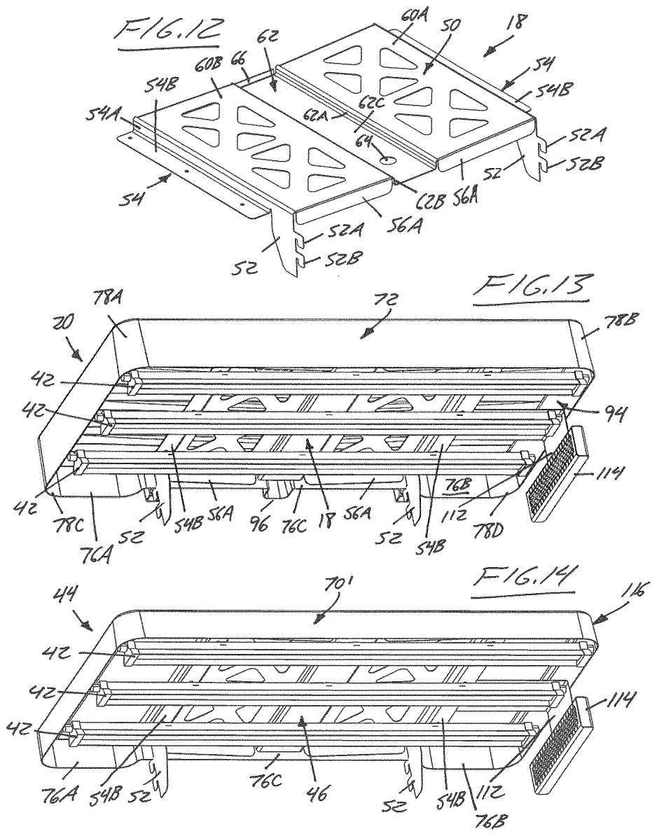

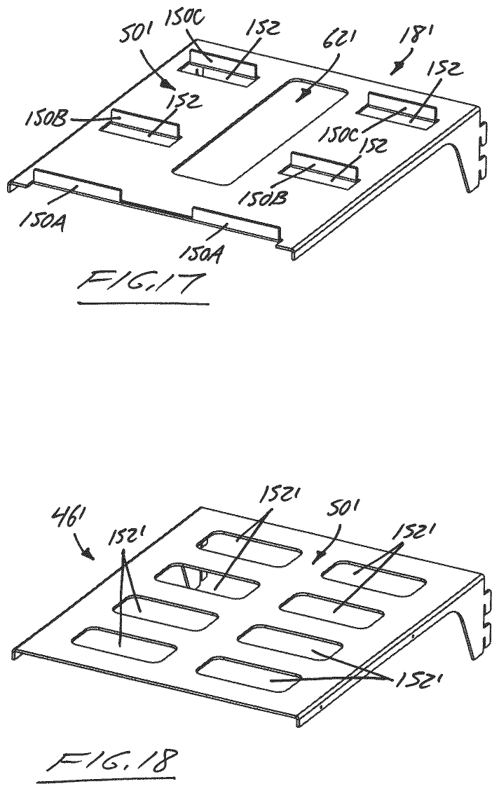

FIGS. 16 to 20 illustrate an alternative embodiment of the growing stand 10′, which in the illustrated example of FIG. 16 is characterized by a lesser number of growing tiers (two, versus the three of the first illustrated embodiment) and by a smaller footprint, but in general construction, is otherwise quite similar to the preceding embodiment, differing therefrom primarily in relation to the shelving of the growing tiers. FIG. 17 shows the modified shelf 18′ of this embodiment, which possesses a simpler geometry than the preceding embodiment, and can therefor be produced more cost efficiently, enabling even better promotion of this smaller “miniaturized” embodiment as a lower cost alternative to the larger unit of the first embodiment. That said, the simpler geometry of the modified shelving 18′ of the second embodiment could likewise be adopted in the larger full-size stand of FIGS. 1 to 14. The growing trays 20′ of the miniaturized embodiment are smaller in size and lack the central bump-out 96 in their rear walls, but are otherwise notably similar to those described earlier, and once again have basin floors characterized by ribbed or corrugated outer regions 106A′, 106B′ on opposing sides of a sloped center channel 102 of rearwardly descending character. As shown, the corrugated or ribbed profile may feature a more densely arrayed quantity of alternating lands 108 and valleys 110 than in the earlier embodiment. On again, the corrugated basin floor characterized by a downward slope of the valleys 110 of each outer region 106A′, 106B′ toward the center channel 102, in contrast to the lands 110 that all reside coplanar with one another in a common horizontal plane of parallel relation to the top rim of the tray 20′.

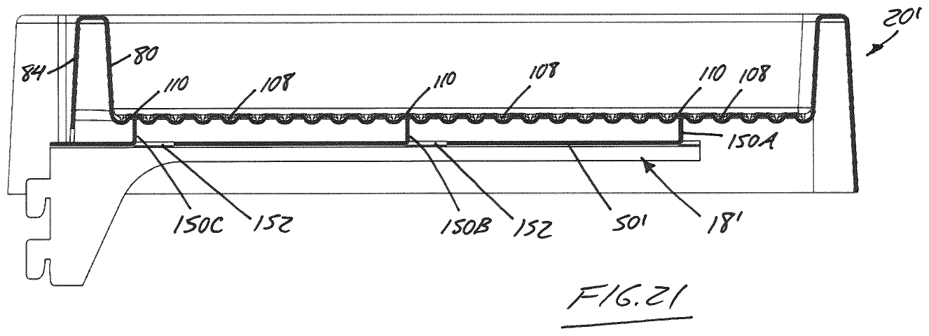

FIG. 17 shows one of the two identical shelves 18′ of the two-tiered second embodiment. The platform 50′ of this shelf 18′ is of flat uniplanar character, unlike the shelves 18 of the earlier embodiment whose platforms 50 were characterized by sloped regions 60A, 60B of inwardly and symmetrically declined angulation toward a central receiving channel 62. The recessed central receiving channel 62 of the preceding embodiment is replaced with a central cutout opening 62′ in the present embodiment, which can be seen in the cross-sectional view of FIG. 20 to accommodate receipt therein of the downwardly protruding mid-ridge that exists in the underside of the tray's basin floor 82 owing to the recessed center channel 102. When the growing tray 20′ is seated upon the shelf 18′, the protruding mid-ridge in the underside of the tray's basin floor 82 thus penetrates downwardly through the central cutout opening 62′ of the shelf 18′ of this embodiment.

Instead of supporting the basin floor 82 of the growing tray 20′ at the undersides of the sloped valleys 108 of the corrugated outer regions 106A′, 106B′ of the growing tray 20′, the modified shelf 18′ of the present embodiment instead supports the corrugated basin floor 82 of the growing tray 20′ at the undersides of the horizontally level lands 110 thereof. For such purpose, the platform 50′ of the modified shelf 18′ features a plurality of up-bent support tabs 150A, 150B, 150C formed integrally therein to stand perpendicularly upright from the otherwise flat uniplanar platform 50′. Two sets of such up-bent support tabs 150A-150C are provided, one set on each side of the center cutout opening 62′. In the illustrated example, there are three up-bent support tabs 150A-150C per set, respectively positioned to align with three different lands of the respective ribbed/corrugated outer region 106A′, 106B′ of the growth tray 20′. In the illustrated example, the frontmost one of the support tabs 150a of each set resides at the front edge of the shelf platform 50, taking the place of the downturned front flanges 56B of the earlier embodiment. The spacing between the frontmost up-bent support tab 150A of each set, the middle up-bent support tab 150B of the set and the rearmost up-bent support tab 150C of the set may be roughly equal, as shown, thereby providing support to the tray 20′ at relatively even intervals across its front to rear depth. Except for the frontmost up-bent support tabs 150A at the front edge of the platform 50, the other four up-bent support tabs 150A, 150B each correspond to a respectively adjacent rectangular cutout 152 that is left in the platform 50′ by the cutting end bending of the support tabs 150A-150C during fabrication of the shelf 18′.

FIGS. 19 and 21 reveal how the tray 20′ rests atop the modified shelf 18′ of the present embodiment, where the entirety of the basin floor 82, including the sloped lowermost valleys 108 thereof, floats above the flat uniplanar platform 50 of the shelf 18′, with the point of physical contact between the shelf 18′ and the tray 20′ being seated receipt of the undersides of some of the lands 110 atop the uppermost edges of the up-bent support tabs 150A-150C. This way, the platform 50 of the shelf 18′ need not have an angulated geometry to conform to the sloped valleys 108 of the ribbed/corrugated basin floor 82 of the growing tray 20′.

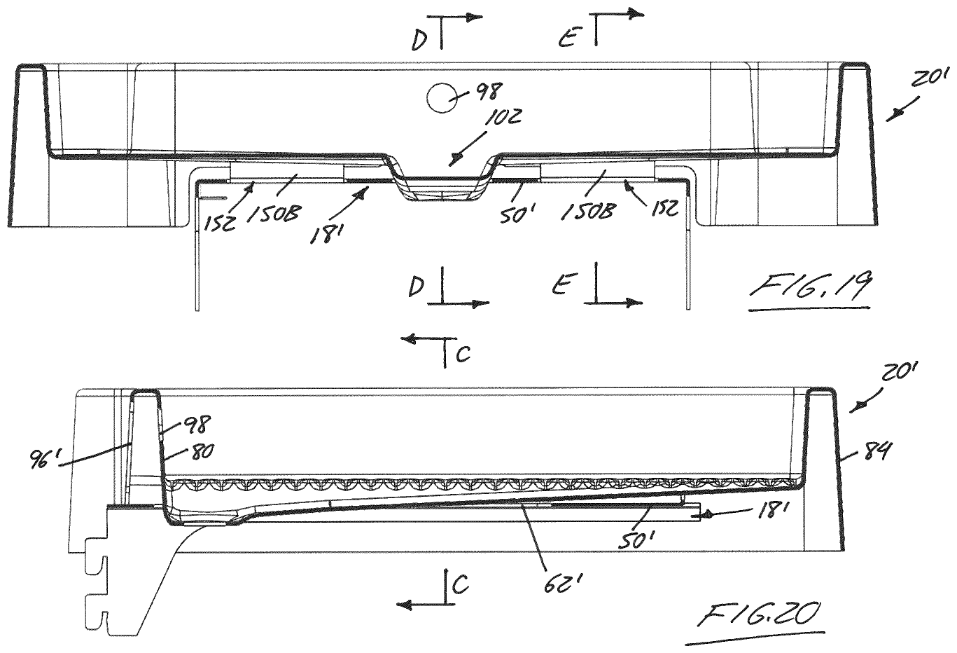

It will be appreciated that the particular quantity and positional layout of the up-bent support tabs 150A-150C may vary from the illustrated example of three equally spaced up-bent support tabs 150A-150C on each half of the platform 50′. FIG. 20 reveals how the outside wall 84 of the perimeter wall channel profile of the second embodiment's growing tray 20′ lacks the rear bump-out 96 of the earlier embodiment, and in its place, instead employs a rear opening or gap 96′ in the outside wall 84 to achieve access to the fill-port aperture 98 in the inside wall 80. FIG. 18 shows how the lamp support 46′ for the lamp canopy 44′ of the second embodiment may differ in configuration from the growth tier shelves 18′ by omission of the up-bent support tabs 150A-150C thereof. The lamp support 46′ instead relies on the flat uniplanar character of platform 50′ alone to support the lamp canopy 44′ at a flat non-corrugated underside thereof. Despite the lack of up-bent support tabs, the lamp support 146 may nonetheless have a plurality of cutouts 152 therein, for example for weight reduction purposes.

Since various modifications can be made in the invention as herein above described, and many apparently widely different embodiments of same made, it is intended that all matter contained in the accompanying specification shall be interpreted as illustrative only and not in a limiting sense.

1. A growing stand for indoor horticulture, comprising:
a supportive framework comprising:
a base; and
an upright support mast attached to said base and standing in erect relation thereto, said support mast having a frontside facing forwardly in a front/rear direction, an opposing backside facing rearwardly in the front/rear direction, and two lateral sides facing oppositely of one another in a lateral direction of orthogonal relationship to said front/rear direction;
one or more shelves mounted or mountable to the upright support mast at respective elevations thereon above the base in positions cantilevering forwardly from the upright support mast in overhead relation to the base, at least a subset of the one or more shelves being adjustably mountable to the upright support mast at different user-selectable elevations thereof;
one or more respective growing trays each of greater width, in the lateral direction, than the upright support mast and each residing or placeable atop a respective shelf among said one or more shelves in a position thereby cantilevered forwardly from the upright support mast in a position spanning laterally across the frontside thereof, each growing tray having a basin floor and a perimeter wall surrounding said basin floor in a manner upstanding therefrom and cooperating therewith to define a fluid-fillable upper basin of the growing tray; and
concealed plumbing routed along the upright support mast in concealed relation behind the frontside, and between the lateral sides, thereof, and comprising flexible hose manipulatable in position to reach different user-selectable plumbing service points at varying elevations on the mast.

2. The stand of claim 1 wherein the upright support mast is shallower in the front and rear directions that it is wide in the lateral direction.

3. The stand of claim 1 wherein the upright support mast is open or openable at the backside thereof, at least at elevations where the one or more shelves are mounted or mountable to provide access to the concealed plumbing.

4. The stand of claim 1 wherein the upright support mast has one or more vertically elongated slots therein to accommodate elevational variation among the one or more growing trays and one or more plumbing connections of the concealed plumbing thereto.

5. The stand of claim 4 wherein the frontside of the upright support mast comprises one or more front panels spanning between the lateral sides of the support mast, and the one or more vertically elongated slots reside in said one or more front panels of the upright support mast.

6. The stand of claim 1 wherein each growing tray has an upwardly recessed shelf cavity in an underside thereof for receiving a platform of the respective shelf in a manner recessed upwardly into said underside of the growing tray for concealment of said platform by said growing tray when seated atop said platform of the shelf.

7. The stand of claim 1 wherein said one or more shelves comprises a plurality of shelves, and a non-lowermost one of the shelves comprises a fan support bracket attached thereto for hanging support therefrom of one or more fans in a position operable to blow air across a plant canopy of an underlying tier that comprises a less elevated one of said shelves.

8. The stand of claim 7 wherein said fan support bracket spans laterally from said non-lowermost one of the shelves to position said one or more fans proximate one end of said underlying tier to blow said air toward an opposing end thereof.

9. The stand of claim 1 wherein a rear section of the perimeter wall of each tray has an inset mid-segment that resides between and is inset forwardly from two end-segments of said rear section of the perimeter wall for inset receipt of the support mast at said inset mid-segment of the growing tray such that said growing tray flanks the support mast at both of said lateral sides thereof.

10. The stand of claim 1 wherein the basin floor of each growing tray slopes downwardly toward a lateral center of the tray.

11. The stand of claim 1 wherein the basin floor of each growing tray comprises a center channel that is laterally centered thereon and runs in the front/rear direction, and at which the basin floor is downwardly and rearwardly sloped.

12. The stand of claim 11 wherein each growing tray has a drain port at or near a rear end of the center channel.

13. The stand of claim 12 wherein said drain port of at least one of the one or more growing trays is fed by both an upper drain inlet and a lower drain inlet, of which the lower drain inlet has a smaller flow area, and resides at a lesser elevation, than said upper drain inlet.

14. The stand of claim 1 wherein at least one of the one or more growing trays comprises a shared drain port fed by both an upper drain inlet and a lower drain inlet, of which the lower drain inlet has a smaller flow area, and resides at a lesser elevation, than said upper drain inlet.

15. A growing stand for indoor horticulture comprising:
a supportive framework comprising:
a base;
an upright support mast attached to said base and standing in erect relation thereto, said support mast having a frontside facing forwardly in a front/rear direction, an opposing backside facing rearwardly in the front/rear direction, and two lateral sides facing oppositely of one another in a lateral direction of orthogonal relationship to said front/rear direction; and
one or more growing tiers each mounted to the upright support mast at a respective elevation thereon above the base in a position of forwardly cantilevered relation to said upright support mast, and overhead relation to the base, for growing of vegetation at each of said one or more tiers;
wherein at least one component of the stand, selected from among:
(a) a respective growing tray of at least one of said one or more tiers, and
(b) an enclosure installed on said base,
has a rear end of that resides adjacent relation to said support mast, and is characterized by an inset mid-segment of said rear end that is of forwardly inset relation to neighbouring outer segments of said rear end that flank said mid-segment on opposing sides thereof, and said inset-mid region of said rear end receives the support mast forwardly inset relation to said neighbouring outer segments of the rear end of said component, whereby said component flanks the support mast at both of said lateral sides thereof.

16. The stand of claim 15 wherein said at least one component includes at least said respective growing tray.

17. The stand of claim 15 wherein said at least one component includes at least said enclosure.

18. (canceled)

19. (canceled)

20. (canceled)

21. (canceled)

22. (canceled)

23. The stand of claim 6 wherein said one or more shelves comprises a plurality of shelves, and an upper subset of the plurality of shelves, each one of which is characterized by presence of another one of the shelves in an underlying position therebeneath, each has at least one lamp installed on an underside of the shelf to cast light onto said another one of the shelves, and said at least one lamp resides at least partially within the lower shelf cavity of the respective growing tray that is seated atop said one of the upper subset of shelves.

24. (canceled)

25. (canceled)

26. (canceled)

27. The stand of claim 10 wherein the basin floor comprises a ribbed profile having alternating lands and valleys, among which the basin floor is sloped downwardly toward the lateral center of the growing tray in the valleys of the ribbed profile, and each shelf comprises a flat platform and a plurality of up-bent support tabs standing upright from said flat platform at locations thereon corresponding to lands of the ribbed profile for seated receipt of the of growing tray on the up-bent support tabs of the shelf at the lands of said ribbed profile.

28. (canceled)

29. The stand of claim 11 wherein the recessed channel in the basin floor forms a downwardly protrusive mid-ridge of the growing tray beneath the upper basin thereof, and each shelf comprises a recessed receiving channel in a topside thereof for receipt of said protrusive mid-ridge of the growing tray.

30. The stand of claim 11 wherein the recessed channel in the basin floor forms a downwardly protrusive mid-ridge of the growing tray beneath the upper basin thereof, and each shelf comprises an opening therein for receipt of said protrusive mid-ridge of the growing tray.

31. (canceled)

32. The stand of claim 13 further comprising a fluid reservoir and a pump operable to pump fluid from said fluid reservoir to at least one of the growing trays, wherein the flow areas of the drain inlets and a pumping rate of the pump are such that a lower drainage rate through the lower drain inlet is lesser than the pumping rate, and an upper drainage rate through the upper drain inlet is not exceeded by the pumping rate.

33-50. (canceled)
